(19) United States
(12) Patent Application Publication
(10) Pub. No.: US 2022/0049111 A1
(43) Pub. Date: Feb. 17, 2022

(54) BIOCIDAL COATINGS

(71) Applicant: Corning Incorporated, Corning, NY (US)

(72) Inventors: Bavani Balakrisnan, Corning, NY (US); Stephen Joseph Caracci, Elmira, NY (US); David Michael Fasano, Maple Glen, PA (US); Joseph Martin Rokowski, Barto, PA (US)

(21) Appl. No.: 17/416,045

(22) PCT Filed: Dec. 4, 2019
(86) PCT No.: PCT/US2019/064349

§ 371 Date: Jun. 18, 2021

Related U.S. Application Data
(60) Provisional application No. 62/782,044, filed on Dec. 19, 2018.

(51) Int. Cl. C09D 5/14; C09D 7/61; C09D 7/63; C09D 133/10; C09D 133/08; C09D 143/02; A01N 59/20; C08K 9/02; C08K 3/40

(52) U.S. Cl. CPC C09D 5/14; C09D 7/61; C09D 7/63; C09D 133/10; C08K 2003/2241; C09D 143/02; A01N 59/20; C08K 9/02; C08K 3/40; C09D 133/08

(57) ABSTRACT

A composition for forming a biocidal coating is provided. The composition has a log reduction of at least 2 and a CIEL*a*b* delta E*value less than about 30.

### CROSS-REFERENCE TO RELATED APPLICATIONS

This application claims the benefit of priority under 35 U.S.C. § 119 of U.S. Provisional Application Ser. No. 62/782,044 filed on Dec. 19, 2018 the content of which is relied upon and incorporated herein by reference in its entirety.

### BACKGROUND

Coatings or compositions such as paint can be applied on a substrate or surface or stored in a container. Over time, the coating or composition can be exposed to a number of undesired contaminants such as bacteria, viruses, mildew, mold, fungi, algae and the like. Exposure to these contaminants can render the coating or composition visually unattractive or unsuitable for a particular purpose or present a health hazard. It can therefore be desirable to mitigate the ability of the undesired contaminants to thrive once in contact with a coating or composition.

### SUMMARY OF THE DISCLOSURE

According to various embodiments of the present disclosure a composition for forming a biocidal coating can have a log reduction of at least 2 and a CIEL*a*b* delta E* value less than about 30.

According to various embodiments of the present disclosure, a dried product of the biocidal composition is disclosed.

According to various embodiments of the present disclosure, an assembly can include a substrate. The assembly can further include a composition for forming a biocidal coating. The biocidal coating can have a log reduction of at least 2 and a CIEL*a*b* delta E*value less than about 30, or a dried product thereof.

According to various further embodiments of the present disclosure, a method of making an assembly includes applying a composition for forming a biocidal coating. The biocidal coating can have a log reduction of at least 2 and a CIEL*a*b* test delta E*less than about 30. The method can further include drying the biocidal composition thereon.

### DETAILED DESCRIPTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

According to various embodiments of the present disclosure, a water-based composition is described that can be effective for forming a biocidal coating. The coating can ultimately be a paint, an elastomeric coating, a caulk, a sealant, a floor polish, a fabric treatment, a stain, a clear coat, or a primer. The effectiveness of the composition as a biocidal coating can be measured as a function of the composition's log reduction. The composition's log reduction value can be relevant to its ability to kill a wide variety of biological organisms to which it is exposed, but can also allow the inorganic glass comprising copper to act as a preservative for the composition during storage (e.g., in a container such as, but not limited to a tank, can, bucket, drum, bottle, or tube).

According to various embodiments, a log reduction of the biocidal coating can be at least about 2, at least about 3, at least about 4, at least about 5, at least about 6, at least about 7, at least about 8, at least about 9, at least about 10, in a range of from about 1 to about 10, about 3 to about 7, about 4 to about 6, or less than, equal to, or greater than about 1, 2, 3, 4, 5, 6, 7, 8, 9, or about 10. The log reduction value can be measured according to the ASTM D2574-16 (2016) Standard test method for resistance of emulsion paints in the container to attack by microorganisms. The biocidal properties of the composition can make it effective for substantially killing a wide variety of biological organisms including bacteria, viruses, and fungi. Where the coating is configured to have biocidal properties with respect to bacteria, suitable examples of bacteria include Staphylococcus aureus, Enterobacter aerogenes, Pseudomonas aeruginosa, Methicillin Resistant Staphylococcus aureus, E. coli, and mixtures thereof.

An active component for providing biocidal activities in the composition, and ultimately the coating, can be an inorganic glass comprising copper component. Where present, the inorganic glass comprising copper component can include a plurality of such components and in total can be in a range of from about 0.01 wt % to about 15 wt % of the composition, about 2 wt % to about 8 wt % about 0.1 wt % to about 2 wt %, about 0.5 wt % to about 1 wt %, less than, equal to, or greater than about 0.01 wt %, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 1.2, 1.4, 1.6, 1.8, 2, 2.2, 2.4, 2.6, 2.8, 3, 3.2, 3.4, 3.6, 3.8, 4, 4.2, 4.4, 4.6, 4.8, 5, 5.2, 5.4, 5.6, 5.8, 6, 6.2, 6.4, 6.6, 6.8, 7, 7.2, 7.4, 7.6, 7.8, 8, 8.2, 8.4, 8.6, 8.8, 9, 9.2, 9.4, 9.6, 9.8, 10, 10.2, 10.4, 10.6, 10.8, 11, 11.2, 11.4, 11.6, 11.8, 12, 12.2, 12.4, 12.6, 12.8, 13, 13.2, 13.4, 13.6, 13.8, 14, 14.2, 14.4, 14.6, 14.8, or about 15 wt %. The inorganic glass portion of the inorganic glass comprising copper component can include any suitable material such as SiO₂, Al₂O₃, CaO, MgO, P₂O₅, B₂O₃, K₂O, ZnO, Fe₂O₃, nanoparticles thereof, or a mixture thereof.

The copper of the inorganic glass comprising copper component can be present in an individual inorganic glass comprising copper component in any suitable amount. For example, the copper can be present in a range of from about 5 wt % to about 80 wt % of the individual inorganic glass comprising copper component, about 10 wt % to about 70 wt %, about 25 wt % to about 35 wt %, about 40 wt % to about 60 wt %, about 45 wt % to about 55 wt %, less than, equal to, or greater than about 5 wt %, 10, 15, 20, 25, 30, 35, 40, 45, 50, 55, 60, 65, 70, 75, or about 80 wt %. In each inorganic glass comprising copper component, the copper portion can independently include a Cu metal, Cu⁺, Cu²⁺, or a combination of Cu⁺ and Cu²⁺. The copper can be non-complexed or can be have a ligand bonded thereto to form a complex. Although the inorganic glass comprising copper component is effective as a biocidal agent, a potential drawback is that the copper offers numerous opportunities for ligands to attach thereto, resulting in complexes that can alter the color of the resulting composition. However, it is possible to pair the inorganic glass comprising copper components with various additional additives in order to limit the extent to which the copper component is complexed and therefore the color of the composition is altered from a standard. For example it is possible to achieve a CIEL*a*b* delta E* between the observed color and a standard of less than about 30, less than about 25, less than about 20, less than about 15, less than about 12, less than about 10, less than about 9, less than about 8, less than about 7, less than about 6, less than about 5, less than about 4, less than about 3, less than about 2, less than about 1, in a range of from about 1 to about 30, about 2 to about 25, about 5 to about 1515, about 3 to about 8, about 4 to about 7, about 5 to about 6, less than, equal to, or greater than about 1, 2, 3, 4, 5, 6, 7, 8, 9, 10, 11, 12, 13, 14, 15, 16, 17, 18, 19, 20, 21, 22, 23, 24, 25, 26, 27, 28, 29 or about 30.

As understood, the CIEL*a*b* color space is a color scale for determining a color. Using this test, the difference (e.g., a delta E*) in color between a standard and observed color can be measured. In this manner, the extent to which the desired color of a coating is altered by the components therein can be measured.

In operation, the copper can be released into the composition to interact with and kill unwanted biological contaminants such as microbes in the composition. An advantage to using the inorganic glass comprising copper components described herein these that the copper is less corrosive, and toxic, than many organic biocidal compounds that are included in corresponding compositions.

Additional components of the composition can include a latex polymer formed or produced by emulsion polymerization, otherwise referred to as one or more emulsion polymers. The one or more emulsion polymers can independently have a redox potential in a range of from about −200 mV to about 200 mV, about −175 mV to about 175 mV, about −150 mV to about 150 mV, about −125 mV to about 125 mV, about −100 mV to about 100 mV, about −75 mV to about 75 mV, about −50 mV to about 50 mV, about −40 mV to about 40 mV, about −30 mV to about 30 mV, about −25 mV to about 25 mV, about −20 mV to about 20 mV, about 15 mV to about 15 mV, about −9 mV to about 9 mV, about −8 mV to about 8 mV, about −7 mV to about 7 mV, about −6 mV to about 6 mV, about −5 mV to about 5 mV, about −4 mV to about 4 mV, about −3 mV to about 3 mV, about −2 mV to about 2 mV, about −1 mV to about 1 mV, less than, equal to, or greater than about −200 mV, −190, −185, −180, −175, −170, −165, −160, −155, −150, −145, −140, −135, −130, −125, −120, −115, −110, −105, −100, −95, −90, −85, −80, −75, −70, −65, −60, −55, −50, −45, −40, −35, −30, −29, −28, −27, −26, −25, −24, −23, −22, −21, −20, −19, −18, −17, −16, −15, −14, −13, −12, −11, −10, −9, −8, −7, −6, −5, −4, −3, −2, −1, 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, or about 200 mV. Controlling the redox potential of the one or more emulsion polymers can be helpful to enhance the stability of the inorganic glass comprising copper component and to minimize discoloration. In embodiments in which the composition includes one or more emulsion polymers, the polymers may independently have a weight-average molecular weight of at least about 25,000 Daltons, at least 50,000 Daltons, at least about 100,000 Daltons, at least about 500,000 Daltons, at least about 1,000,000 Daltons in a range of from about 25,000 Daltons to about 10,000,000 Daltons, about 60,000 Daltons to about 2,000,000 Daltons, about 100,000 Daltons to about 1,000,000 Daltons, less than, equal to, or greater than about 25,000 Daltons, 50,000, 75,000, 100,000, 125,000, 150,000, 175,000, 200,000, 225,000, 250,000, 275,000, 300,000, 325,000, 350,000, 375,000, 400,000, 425,000, 450,000, 475,000, 500,000, 1,000,000, 2,000,000, 3,000,000, 4,000,000, 5,000,000, 6,000,000, 7,000,000, 8,000,000, 9,000,000, or about 10,000,000 Daltons.

According to various embodiments, the emulsion polymers can include one or more repeating units derived from monomers that can include a polymerizable phosphorous-containing monomer, an acetoacetoxy-functional acrylate, an acetoacetoxy-functional methacrylate, an acetoacetoxy-ethylmethacrylate, or a mixture thereof. Examples of suitable polymerizable phosphorous monomer include those having the structure according to Formula I, Formula II, or a mixture thereof:

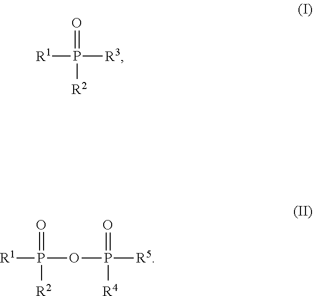

In either of Formula I or Formula II, R¹, R², R³, R⁴, and R⁵, can be independently selected from —H, —OH, and substituted or unsubstituted (C₁-C₂₀)hydrocarbyl comprising at least one unsaturated R¹, R², R³, R⁴, and R⁵ is a polymerizable group. In further embodiments, R¹, R², R³, R⁴, and R⁵, are independently selected from —H, —OH, substituted or unsubstituted (C₁-C₂₀)alkyl, substituted or unsubstituted (C₁-C₂₀)alkenyl, substituted or unsubstituted (C₁-C₂₀)alkynyl, substituted or unsubstituted (C₁-C₂₀)alkoxy, substituted or unsubstituted (C₁-C₂₀)acyl, substituted or unsubstituted (C₁-C₂₀)cycloalkyl, substituted or unsubstituted (C₁-C₂₀)aryl, and mixtures thereof. Specific examples of polymerizable phosphorous-containing monomers may include a vinyl phosphonic acid monomer, an allyl phosphonic acid monomer, a 2-acrylamido-2-methylpropanephosphonic acid monomer, an α-phosphonostyrene monomer, a 2-methylacrylamido-2-methylpropanephosphonic acid monomer, a 1,2-ethylenically unsaturated (hydroxy)phosphinylalkyl (meth)acrylate monomer, a (hydroxy)phosphinylmethyl methacrylate, a dihydrogen phosphate monomer (e.g., monomers chosen from 2-phosphoethyl (meth)acrylate, 2-phosphopropyl (meth)acrylate, 3-phosphopropyl (meth)acrylate, and 3-phospho-2-hydroxypropyl (meth)acrylate), or mixtures thereof.

Acetoacetoxy-ethylmethacrylate monomers can be repeating units in an emulsion polymer. Phosphate acrylate monomer and acetoacetoxy-ethylmethacrylate can be a useful monomer in a polymer composition because it can scavenge copper ions and can further react with the copper ions to create a slow controlled release of copper ions from the inorganic glass comprising copper component. Moreover, the capture of copper by Acetoacetoxy-ethylmethacrylate can help to reduce color generation because of the pendant nature of Acetoacetoxy-ethylmethacrylate structure, which makes the copper releasable under certain conditions.

The composition can include a variety of initiators. The initiators can be water soluble and can include, for example, sodium persulfate (Na₂S₂O₈) and potassium persulfate; peroxides such as hydrogen peroxide and tert-butyl hydroperoxide (t-BHP); and azo compounds such as VAZO™ initiators, commercially available from The Chemours Company. The composition can further include an activator such as a bisulfite, a metabisulfite, ascorbic acid, erythorbic acid, sodium formaldehyde sulfoxylate, ferrous sulfate, ferrous ammonium sulfate, and ferric ethylenediamine tetraacetic acid.

Reducing the amount of undesired color change in the compositions described herein can be further controlled by maintaining a pH of the composition to be in a range of from about 6 to about 9.5, about 7.5 to about 9, about 7.5 to about 8.5, less than, equal to, or greater than about 6, 6.5, 7, 7.5, 8, 8.5, 9, or about 9.5. Maintaining a pH in this range can be helpful to influence the reactivity of copper ions with other materials in the composition, thus affecting the color of the composition as a whole. Moreover, the pH of the composition can affect the shelf life of the composition and viscosity of the composition. To help maintain the desired pH, the composition can include a pH modifier or mixture of pH modifiers. The pH modifier or modifiers can independently have a pKa in a range of from about 4.7 to about 1414, about 5 to about 9.5, about 6 to about 9.5, about 7 to about 9.5, less than, equal to, or greater than about 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.5, 9.6, 9.7, 9.8, 9.9, 10, 10.1, 10.2, 10.3, 10.4, 10.5, 10.6, 10.7, 10.8, 10.9, 11, 11.1, 11.2, 11.3, 11.4, 11.5, 11.6, 11.7, 11.8, 11.9, 12, 12.1, 12.2, 12.3, 12.4, 12.5, 12.6, 12.7, 12.8, 12.9, 13, 13.1, 13.2, 13.3, 13.4, 13.5, 13.6, 13.7, 13.8, 13.9, or about 1414. The pH modifier can be present in the composition in a range of from about 0.1 wt % to about 5 wt % of the composition, about 0.5 wt % to about 2 wt %, about 1 wt % to about 1.5 wt %, less than, equal to, or greater than about 0.1 wt %, 0.5, 1, 1.5, 2, 2.5, 3, 3.5, 4, 4.5, or about 5 wt %.

Specific non-limiting examples of suitable pH modifiers include those selected from the group of Group (I) hydroxides; Group (II) hydroxides; and organic amines. More specific non-limiting examples of suitable pH modifiers include those selected from metal hydroxides, ammonium hydroxide, and amines, wherein the amines are amines of the formula NH₂R, wherein R is selected from the group consisting of H, OR′ or —R′—OH, wherein R′ is selected from the group consisting of H, alkane, and alkylene. Specific further non-limiting examples of suitable pH modifiers include potassium hydroxide, sodium hydroxide, 2-amino-2methyl-1-propanol, ammonia, 2-dimethylamino-2-methyl-1-propanol, 2-butylaminoethanol, N-methylethanolamine, 2-amino-2-methyl-1-propanol, monoisopropanolamine, monoethanolamine, N,N dimethylethanolamine, N-butyldiethanolamine, 2-amino-2-ethyl-1,3-propanediol, 2-amino-2-hydroxymethyl-1,3-propanediol, triethanolamine. Specific further non-limiting examples of suitable pH modifiers include a mixture of at least one of potassium hydroxide and sodium hydroxide and at least one of 2-amino-2methyl-1-propanol and ammonia, in which at least one of potassium hydroxide and sodium hydroxide, or a mixture thereof are the major component of the pH modifier mixture. In some embodiments, it may be desirable to avoid a pH modifier that includes ammonia. This is because ammonia can engage in undesirable reactions with the copper and create undesirable odors in the composition.

In some embodiments, the composition may further include a dispersant. The dispersant can be used to help ensure that the pigments. of the composition are sufficiently dispersed throughout the composition. As understood pigments may refer to an actual pigment, a colorant, or an extender. The dispersant can be in a range of from about 0.1 wt % to about 5 wt % of the composition, about 0.5 wt % to about 2 wt %, about 0.7 wt % to about 1.5 wt %, about 1 wt % to about 1.25 wt %, about 0.1 wt % to about 0.5 wt %, less than, equal to, or greater than about 0.2 wt %, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, or about 5 wt %. non-limiting examples of suitable dispersants include salts of a carboxylic acid.

According to further embodiments of the present disclosure, the composition can include a defoamer. The defoamer can be used to help the composition avoid forming air bubbles. Air bubbles, in turn can cause defects in the film that is ultimately formed from the composition. The defoamer can include be based on mineral oil, silicone, siloxane, fatty alcohol, fatty acids or esters, polyethylene glycol or polyacrylates. According to further embodiments, the defoamer can be free of a silicone. It can be beneficial for the defoamer to be free of a silicone because silicones may unfavorably alter the distribution of copper in the inorganic glass comprising copper component.

Depending on the composition's function, it may be desirable to include a rheology modifier or thickener in the composition. For example, if the composition is a paint, the viscosity of the of the paint should be low enough to facilitate easy spreading on a substrate by a user. However, the viscosity should be high enough to prevent undesired flow of the paint once applied to the substrate. Where present, the rheology modifier can be in a range of from about 0.1 wt % to about 5 wt % of the composition, about 0.5 wt % to about 2 wt %, about 0.7 wt % to about 1.5 wt %, about 1 wt % to about 1.25 wt %, less than, equal to, or greater than about 0.1 wt %, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, or about 5 wt %. Examples of suitable rheological modifiers include a thickener comprising hydroxyethyl cellulose, methyl cellulose, carboxymethyl cellulose, hydroxyethylcellulose, an alkali swellable emulsion, a hydrophobically modified ethoxylated urethane, hydrophobically modified analogues, natural or synthetic gums thereof, or a mixture thereof.

As stated herein, the rheology modifier can control a viscosity of the composition. According to various embodiments, the viscosity of the composition can be controlled to be in a range of from about 70 KU to about 130 KU, about 75 KU to about 120 KU, about 80 KU to about 115 KU, about 90 KU to about 110 KU, about 95 KU to about 105 KU, less than, equal to, or greater than about 70 KU, 75, 80, 85, 90, 95, 100, 105, 110, 115, 120, 125, or about 130 KU. The viscosity can be measured using any suitable instrument such as a Brookfield KU-2 viscometer. Other rheological properties of the composition that can be controlled can include the ability for the compositions to be resistant to settling and syneresis during storage; the ability of the composition to be applied by a brush or roller; the spray or flow level of the composition; all of which can control the finish of the composition.

According to some embodiments, the compositions described herein can be free of a chelator. The chelator can function to bind components of the composition, which can help to keep the components in solution or to prevent certain components from participating in undesired reactions. However, the chelator can also bind or complex with the copper thus rendering the copper unsuitable as a biocide. If a chelator is included, it can be important to carefully select certain chelators that either will not complex with the copper of the inorganic glass comprising copper component or will not react to such an extent that the copper cannot function as a biocidal agent. An example of a suitable chelator that may be used or not, depending on the particular application, is ethylenediaminetetraacetic acid (EDTA).

According to various embodiments, the composition can include one or more pigments, which may include a pigment, a colorant or an extender. The colorants can give the composition its color, when for example, the composition is a paint composition. Where present, any of the pigment, extender, or the colorant can independently be in a range of from about 0.1 wt % to about 30 wt % of the composition, about 0.2 wt % to about 10 wt %, about 0.5 wt % to about 7 wt %, about 0.6 wt % to about 5 wt %, about 0.7 wt % to about 1 wt %, less than, equal to, or greater than about 0.1 wt %, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, or 30 wt %. There are many suitable pigments, colorants, or extenders that can be included in the composition. For example, suitable extenders include clay, talc, aluminum trihydrate, barium sulfate, nepheline syenite, CaCO₃, silica, a flattening agent, zinc oxide, or a mixture thereof. An example of a pigment may include TiO₂. According to some embodiments, it may be desirable for the composition to be free of a colorant that includes manganese because manganese can react with copper and thus render copper unsatisfactory as a biocidal agent. According to various embodiments, the clay can serve as a pigment that can additionally promote additional desired properties in the composition. For example, Attapulgite, a grade of clay, can be used as a rheological modifier that is capable of increasing viscosity of the composition. According to some embodiments, the clay can include hydrous aluminum phyllosilicate and in some examples iron, magnesium, alkali metals, alkaline earth metals, or mixtures thereof.

The compositions described herein can be formed according to any suitable method. For example, the compositions described herein can be formed by combining any combination or sub-combination of the components described herein to form a composition precursor. The composition precursor can then be mixed at a low or high shear in a aqueous medium to form the composition. In further embodiments, all of the components of the composition may be present as a powder mixture. The powder mixture may be mixed and then water may be added to disperse the components and form a liquid composition.

The composition can be dried to form a dried product. The dried product can be a film or layer having any desired thickness. Drying can be accomplished by simply exposing the composition to ambient conditions. In some embodiments, it may be desirable to expose the dried or even a semi-dried product to a secondary post-curing procedure. According to various embodiments, drying or a secondary post-curing procedure, can be accomplished, or aided, by exposing the composition to heat, reduced humidity or increased air flow or solar radiation.

In the final dried product, it can be desirable to have the inorganic glass comprising copper component heterogeneously distributed about the dried product. For example, it can be desirable to have a major portion of the inorganic glass comprising copper component located proximate to a surface of the dried product. For example, in a dried product, over 50 wt % of the inorganic glass comprising copper can be found between a plane defined by a surface of the dried product and a substantially parallel plane extending through the center of the dried product. For example, about 50 wt % to about 100 wt % of the inorganic glass comprising copper component can be located proximate to the surface of the dried product, or about 55 wt % to about 95 wt %, about 60 wt % to about 90 wt %, about 65 wt % to about 85 wt %, about 70 wt % to about 80 wt %, less than, equal to, or greater than about 55 wt %, 60, 65, 70, 75, 80, 85, 90, 95, or about 100 wt %. Locating the major portion of the inorganic glass comprising copper component proximate to the surface of the dried product can be desirable to increase the access of the copper to any microbes to which the dried product is exposed.

According to some embodiments, the dried product can further include a secondary coat of material substantially covering the dried product. The coat can be a secondary coat of a sealant material or a bottom primer coat. According to some embodiments, the coat covering the dried product can be substantially porous to allow copper released from the inorganic glass comprising copper to be released through the coat to an external environment. In further embodiments, the dried product can be a top coat that is applied over a surface or another product. In some embodiments, where the dried product is a top coat, the composition can be spray coated to the surface of the product to which it is coated.

The composition forming the dried product can be applied to a substrate. For example, if the composition is a paint, the composition can be applied to a substrate including wood, a plastic, a metal, a ceramic, a stone, cement, drywall, fiberboard, paint, or a mixture thereof. In some embodiments, a primer material can be applied to the substrate and the composition can be applied thereon.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “alkynyl” as used herein refers to straight and branched chain alkyl groups, except that at least one triple bond exists between two carbon atoms. Thus, alkynyl groups have from 2 to 40 carbon atoms, 2 to about 20 carbon atoms, or from 2 to 12 carbons or, in some embodiments, from 2 to 8 carbon atoms. Examples include, but are not limited to —C≡CH, —C≡C(CH₃), —C≡C(CH₂CH₃), —CH₂C≡CH, —CH₂C≡C(CH₃), and —CH₂C≡C(CH₂CH₃) among others.

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. An acyl group can include 0 to about 12, 0 to about 20, or 0 to about 40 additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number offing carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined herein. Representative substituted cycloalkyl groups can be mono-substituted or substituted more than once, such as, but not limited to, 2,2-, 2,3-, 2,4-2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

The term “aryl” as used herein refers to cyclic aromatic hydrocarbon groups that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include about 1 to about 12, about 1 to about 20, or about 1 to about 40 carbon atoms bonded to the oxygen atom, and can further include double or triple bonds, and can also include heteroatoms. For example, an allyloxy group or a methoxyethoxy group is also an alkoxy group within the meaning herein, as is a methylenedioxy group in a context where two adjacent atoms of a structure are substituted therewith.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b})hydrocarbyl, wherein a and b are integers and mean having any of a to b number of carbon atoms. For example, (C₁-C₄)hydrocarbyl means the hydrocarbyl group can be methyl (C₁), ethyl (C₂), propyl (C₃), or butyl (C₄), and (C₀-C_{b})hydrocarbyl means in certain embodiments there is no hydrocarbyl group.

The term “weight-average molecular weight” as used herein refers to M_{w}, which is equal to ΣMᵢ²nᵢ/ΣMᵢnᵢ, where nᵢ is the number of molecules of molecular weight Mᵢ. In various examples, the weight-average molecular weight can be determined using light scattering, small angle neutron scattering, X-ray scattering, gel permeation chromatography, and sedimentation velocity.

The polymers described herein can terminate in any suitable way. In some embodiments, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

### Examples

Various embodiments of the present disclosure can be better understood by reference to the following Examples which are offered by way of illustration. The present disclosure is not limited to the Examples given herein.

Three paint formulations were prepared and are designated Example 1, Example 2, and Example 3, respectively. Each of Examples 1, 2, and 3 were formed by mixing the components identified in Table 1, Table 2, and Table 3, respectively. The components of each respective Example were mixed to form a substantially homogenous mixture.

TABLE 1
Components of Example 1

| | | | | Pounds | |
|---|---|---|---|---|---|
| | | | | per 100 | |
| Trade Name | Manufacturer | Chemical Name | Function | Gal | Wt % |
| Water | | | | 210.2 | 18.7 |
| Tamol 165A | Dow Chemical, Midland | Ammonium salt | Dispersant | 5.0 | 0.4 |
| | Hills, MI | copolymer | | | |
| Surfynol 104A | Air Products, Allentown, | Tetramethyl decyne | Surfactant | 1.7 | 0.2 |
| | PA | diol | | | |
| MO 2111 | BASF, Ludwigshafen, | Mineral Oil | Defoamer | 1.7 | 0.2 |
| | Germany | | | | |
| Ti-Pure R-902 | DuPont, Wilmington, DE | Titanium Dioxide | Pigment | 210.0 | 18.6 |
| Minex 4 | The Cary Co/Unimin, | Sodium Potassium | Extender, | 190.0 | 16.9 |
| | Addison, IL | Alumino Silicate | Filler | | |
| Diafil 525 | Imerys, Paris, France | Diatomaceous Earth | Silica | 25.0 | 2.2 |
| | | | Flatting | | |
| | | | Agent | | |
| Attagel 50 | | Attapulgite Clay | Thixotrope | 2.5 | 0.2 |
| | EPS | | | | |
| EP52741 | | Acrylic emulsion | Film | 442.0 | 39.2 |
| | | | Forming | | |
| | | | Binder | | |
| Amm. Hydroxide | | Aqueous ammonia | pH | 0.8 | 0.1 |
| | | | adjuster | | |
| EPS 9147 | EPS, Moon Township, | | Coalescent | 9.0 | 0.8 |
| | PA | | | | |
| MO2111 | BASF, Ludwigshafen, | Mineral Oil | Defoamer | 1.0 | 0.1 |
| | Germany | | | | |
| NaNO2 (4%) | | Sodium Nitrite | Flash Rust | 8.0 | 0.7 |
| | | | Inhibitor | | |
| RM-2020 | Dow Chemical, Midland | Polyurethane | Thickener | 8.0 | 0.7 |
| | Hills, MI | | | | |
| RM-8W | Dow Chemical, Midland | Polyurethane | Thickener | 0.8 | 0.1 |
| | Hills, MI | | | | |
| Guardiant | Corning, Corning, NY | Glass Copper | Biocide | 50.0 | 1.0 |

| | | |
|---|---|---|
| Total | 1126.7 | 100.0 |

TABLE 2
Components of Example 2

| | | | | Pounds | |
|---|---|---|---|---|---|
| Trade | | | | per 100 | Weight |
| Name | Manufacturer | Chemical Name | Function | Gallons | % |
| Water | | Solvent | | 60.5 | 5.66 |
| Tamol | Dow Chemical, Midland Hills, MI | Ammonium Salt of | Pigment | 4.3 | 0.40 |
| 1124 | | Polycarboxylic acid | Dispersant | | |
| Propylene | | Glycol | Antifreeze | 6.5 | 0.61 |
| Glycol | | | | | |
| TEGO | Evonik, Essen, Germany | Polyether-Siloxane | Defoamer | 3.5 | 0.33 |
| 1488 | | Emulsion/Defoamer | | | |
| Ti-Pure R- | DuPont, Wilmington, DE | Titanium | Pigment | 200.0 | 18.7 |
| 706 | | Dioxide/Pigment | | | |
| OmyCarb 5 | OMYA, Oftrinn, Switzerand | Calcium Carbonate | Extender, | 25.0 | 2.34 |
| | | | Filler | | |
| Minex 7 | The Cary Co/Unimin | Sodium Potassium | Extender, | 25.0 | 2.34 |
| | | Alumino silicate | Filler | | |
| Diafil 525 | Imerys, Paris, France | Diatomaceous Earth | Silica | 8.0 | 0.75 |
| | | | Flatting | | |
| | | | Agent | | |
| Water | | Solvent | | 50.1 | 4.68 |
| Byk 022 | BYK, Wesel, Germany | Mixture of emulsified | Defoamer | 1.5 | 0.14 |
| | | polysiloxanes | | | |
| Rhoplex | Dow Chemical, Midland Hills, MI | Acrylic emulsion/Film | Film | 422.7 | 39.51 |
| VSR-2015 | | Forming Binder | Forming | | |
| | | | Binder | | |
| Ropaque | Dow Chemical, Midland Hills, MI | Polystyrene emulsion, | Synthetic | 47.0 | 4.39 |
| Ultra | | Non-film forming | Hiding | | |
| | | | pigment | | |
| Propylene | | Glycol/Antifreeze | Antifreeze | 6.5 | 0.61 |
| Glycol | | | | | |
| AMP-95 | Angus, Buffalo Grove, IL | Amino alcohol | pH | 3.0 | 0.28 |
| | | | Adjuster | | |
| Acrysol | Dow Chemical, Midland Hills, MI | Polyurethane | Thickener | 39.2 | 3.66 |
| RM- | | | | | |
| 2020NPR | | | | | |
| Acrysol | Dow Chemical, Midland Hills, MI | Polyurethane | Thickener | 7.2 | 0.67 |
| RM-8W | | | | | |
| Water | | Solvent | Solvent | 148.8 | 13.91 |
| Guardiant | Corning, Corning, NY | Copper Glass | Biocide | 50.0 | 1.03 |

| | | |
|---|---|---|
| Totals | 1069.8 | 100.00 |

TABLE 3
Components of Example 3

| | | | | Pounds | |
|---|---|---|---|---|---|
| | | | | per 100 | |
| Trade Name | Manufacturer | Chemical Name | Function | Gallons | Wt % |
| Water | | Solvent | | 250 | 22.8 |
| PG | | Propylene Glycol | Antifreeze | 10.0 | 0.9 |
| Nat Plus 330 | Ashland, Covington, KY | Hydroxyethylcellulose | Thickener | 2.2 | 0.2 |
| AMP-95 | Angus, Buffalo Grove, IL | Aminoalcohol | pH Adjuster | 3.0 | 0.3 |
| FoamStar A-38 | BASF, Ludwigshafen, | Polyorganosilicone | Defoamer | 2.5 | 0.2 |
| | Germany | | | | |
| Tamol 1124 | Dow Chemical, Midland | Ammonium Salt of | Pigment | 3.6 | 0.3 |
| | Hills, MI | Polycarboxylic acid | Dispersant | | |
| Carbowet 106 | Evonik, Essen, Germany | Nonionic Surfactant | Wetting | 3.0 | 0.3 |
| | | | Agent | | |
| Tronox CR-826 | Tronox, Stamfort, CT | Titanium Dioxide | Pigment | 200.0 | 18.2 |
| Minex 7 | The Cary Co/Unimin | Sodium Potassium Alumino | Extender | 50.0 | 4.6 |
| | | silicate | Filler | | |
| Optiwhite MX | Burgess, Sandersville, GA | Calcined Clay | Flatting | 75.0 | 6.8 |
| | | | Agent | | |
| Water | | Solvent | Solvent | 67.1 | 6.1 |
| Avicor 384 | Celanese, Irving, TX | Vinyl acetate-butylacrylate | Film | 392.3 | 35.8 |
| | | copolymer emulsion | Forming | | |
| | | | Binder | | |
| Celvaset PL1000 | Celanese, Irving, TX | | Coalescent | 10.0 | 0.9 |
| RM-825 | Dow Chemical, Midland | Polyurethane | Thickener | 14.0 | 1.3 |
| | Hills, MI | | | | |
| FoamStar A-38 | BASF, Ludwigshafen, | Polyorganosilicone | Defoamer | 2.5 | 0.2 |
| | Germany | | | | |
| Guardiant | Corning, Corning, NY | Copper Glass | Biocide | 50.0 | 1 |

| | | |
|---|---|---|
| Total | 1096.2 | 100.0 |

The log reduction values for each of Examples 1, 2, and 3 were determined according to ASTM D2574-16 (2016). The log kill values are presented in Table 4.

TABLE 4
Log Reduction Values for Examples
1, 2, and 3

| Example | Log Reduction | Standard Deviation |
|---|---|---|
| 1 | 1.57 | 0.23 |
| 2 | 6.29 | 0.00 |
| 3 | 2.64 | 0.14 |

The color of each of Example 1, 2, and 3 were examined using CIEL*a*b* coordinates. The CIEL*a*b* coordinates for each of Examples 1, 2, and 3 are presented in 5. To Examine the color properties affected by adding Guardiant, respective comparative examples to Examples 1, 2, and 3 (designated CE1, CE2, and CE3, respectively) were prepared differing only by being free of any Guardiant

TABLE 5
CIEL*a*b* coordinates for Examples
1, 2, and 3

| Example | L* | a* | b* |
|---|---|---|---|
| 1 | 90.97 | −1.13 | 2.22 |
| 2 | 92.35 | −0.88 | 4.4 |
| 3 | 94.32 | −0.99 | 5.63 |
| CE1 | 96.67 | −0.73 | 2.34 |
| CE2 | 97.52 | −0.73 | 1.18 |
| CE3 | 99.31 | −0.74 | 2.12 |

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

### Additional Embodiments

The following exemplary embodiments are provided, the numbering of which is not to be construed as designating levels of importance:

Embodiment 1 provides a composition for forming a biocidal coating having a log reduction of at least 2 and a CIEL*a*b* delta E* less than about 30.

Embodiment 2 provides the composition of Embodiment 1, wherein the log reduction is at least 3.

Embodiment 3 provides the composition of any one of Embodiments 1 or 2, wherein the CIEL*a*b* delta E*is less than about 6.

Embodiment 4 provides the composition of any one of Embodiments 1-3, wherein the composition comprises:

an inorganic glass comprising copper;

one or more emulsion polymers;

a pH modifier; and

water.

Embodiment 5 provides the composition of Embodiment 4, wherein the inorganic glass comprising copper is in a range of from about 0.01 wt % to about 15 wt % of the composition.

Embodiment 6 provides the composition of any one of Embodiments 4 or 5, wherein the inorganic glass comprising copper is in a range of from about 2 wt % to about 8 wt % of the composition.

Embodiment 7 provides the composition of any one of Embodiments 4-6 wherein the inorganic glass comprises SiO₂, Al₂O₃, CaO, MgO, P₂O₅, B₂O₃, K₂O, ZnO, Fe₂O₃, or a mixture thereof.

Embodiment 8 provides the composition of any one of Embodiments 4-7, wherein the inorganic glass comprises SiO₂ nanoparticles, alumina nanoparticles, or mixtures thereof.

Embodiment 9 provides the composition of any one of Embodiments 4-8, wherein the copper is in a range of from about 5 wt % to about 80 wt % of the inorganic glass comprising copper.

Embodiment 10 provides the composition of any one of Embodiments 4-9, wherein the copper is in a range of from about 25 wt % to about 40 wt % of the inorganic glass comprising copper.

Embodiment 11 provides the composition of any one of Embodiments 4-10, wherein the copper is Cu metal, Cu⁺, Cu²⁺, or a combination of Cu⁺ and Cu²⁺.

Embodiment 12 provides the composition of any one of Embodiments 4-11, wherein the one or more emulsion polymers have a redox potential in a range of from about −200 mV to about 200 mV.

Embodiment 13 provides the composition of any one of Embodiments 4-12, wherein the one or more emulsion polymers have a weight-average molecular weight of at least 25,000 Daltons.

Embodiment 14 provides the composition of any one of Embodiments 4-13, wherein the one or more emulsion polymers have a weight-average molecular weight of at least 1,000,000 Daltons.

Embodiment 15 provides the composition of any one of Embodiments 4-14, wherein the one or more emulsion polymers have a weight-average molecular weight in a range of from about 25,000 Daltons to about 1,000,000 Daltons.

Embodiment 16 provides the composition of any one of Embodiments 4-15, wherein the one or more emulsion polymers have a weight-average molecular weight in a range of from about 100,000 Daltons to about 1,000,000 Daltons.

Embodiment 17 provides the composition of any one of Embodiments 4-16, wherein one or more emulsion polymers include a repeating unit derived from a polymerizable phosphorous-containing monomer, an acetoacetoxy-functional acrylate, an acetoacetoxy-functional methacrylate, an acetoacetoxy-ethylmethacrylate, or a mixture thereof.

Embodiment 18 provides the composition of Embodiment 17, wherein the polymerizable phosphorous monomer comprises the structure according to Formula I, Formula II, or a mixture thereof:

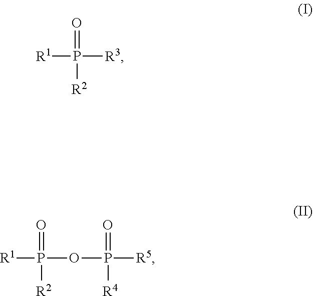

wherein R¹, R², R³, R⁴, and R⁵, are independently selected from —H, —OH, and substituted or unsubstituted (C₁-C₂₀)hydrocarbyl comprising at least one unsaturation R¹, R², R³, R⁴, and R⁵ is a polymerizable group.

Embodiment 19 provides the composition of Embodiment 18, wherein R¹, R², R³, R⁴, and R⁵, are independently selected from —H, —OH, substituted or unsubstituted (C₁-C₂₀)alkyl, substituted or unsubstituted (C₁-C₂₀)alkenyl, substituted or unsubstituted (C₁-C₂₀)alkynyl, substituted or unsubstituted (C₁-C₂₀)alkoxy, substituted or unsubstituted (C₁-C₂₀)acyl, substituted or unsubstituted (C₁-C₂₀)cycloalkyl, substituted or unsubstituted (C₁-C₂₀)aryl, and mixtures thereof.

Embodiment 20 provides the composition of any one of Embodiments 4-19, wherein a pKa of the pH modifier is in a range of from about 4.7 to about 9.5.

Embodiment 21 provides the composition of any one of Embodiments 4-20, wherein a pKa of the pH modifier is in a range of from about 7 to about 9.

Embodiment 22 provides the composition of any one of Embodiments 4-21, wherein the pH modifier is in a range of from about 0.1 wt % to about 5 wt % of the composition.

Embodiment 23 provides the composition of any one of Embodiments 4-22, wherein the pH modifier is in a range of from about 0.1 wt % to about 1.3 wt % of the composition.

Embodiment 24 provides the composition of any one of Embodiments 4-23, wherein the pH modifier is selected from the group consisting of Group (I) hydroxides; Group (II) hydroxides; and organic amines.

Embodiment 25 provides the composition of any one of Embodiments 4-24, wherein the pH modifier is selected from metal hydroxides, ammonium hydroxide, and amines, wherein the amines are amines of the formula NH₂R, wherein R is selected from the group consisting of H, OR′ or —R′—OH, wherein R′ is selected from the group consisting of H, alkane, and alkylene.

Embodiment 26 provides the composition of any one of Embodiments 4-25, wherein the pH modifier comprises potassium hydroxide, sodium hydroxide, 2-amino-2methyl-1-propanol, ammonia, 2-dimethylamino-2-methyl-1-propanol, 2-butylamino ethanol, N-methylethanolamine, 2-amino-2-methyl-1-propanol, monoisopropanolamine, monoethanolamine, N,N dimethylethanolamine, N-butyldiethanolamine, 2-amino-2-ethyl-1,3-propanediol, 2-amino-2-hydroxymethyl-1,3-propanediol, triethanolamine, or a mixture thereof.

Embodiment 27 provides the composition of any one of Embodiments 4-26, wherein the pH modifier comprises a mixture of at least one of potassium hydroxide and sodium hydroxide and at least one of 2-amino-2methyl-1-propanol and ammonium, wherein at least one of potassium hydroxide and sodium hydroxide, or a mixture thereof are the major component of the pH modifier mixture.

Embodiment 28 provides the composition of any one of Embodiments 4-27, further comprising at least one colorant.

Embodiment 29 provides the composition of Embodiment 28, wherein the colorant is in a range of from about 0.1 wt % to about 22 wt % of the composition.

Embodiment 30 provides the composition of any one of Embodiments 38 or 29, wherein the colorant is in a range of from about 1 wt % to about 5 wt % of the composition.

Embodiment 31 provides the composition of any one of Embodiments 4-30, further comprising at least one extender.

Embodiment 32 provides the composition of Embodiment 31, wherein the extender is in a range of from about 0.1 wt % to about 15 wt % of the composition.

Embodiment 33 provides the composition of any one of Embodiments 31 or 32, wherein the extender is in a range of from about 1 wt % to about 5 wt % of the composition.

Embodiment 34 provides the composition of any one of Embodiments 4-33, wherein the extender comprises clay, talc, TiO₂, aluminum trihydrate, nepheline syenite, CaCO₃, silica, a flattening agent, barium sulfate, zinc oxide, or a mixture thereof.

Embodiment 35 provides the composition of any one of Embodiments 4-34, further comprising at least one pigment.

Embodiment 36 provides the composition of Embodiment 35, wherein the pigment is in a range of from about 0.1 wt % to about 30 wt % of the composition.

Embodiment 37 provides the composition of any one of Embodiments 35 or 36, wherein the pigment is in a range of from about 1 wt % to about 5 wt % of the composition.

Embodiment 38 provides the composition of any one of Embodiments 35-37, wherein the pigment is TiO₂.

Embodiment 39 provides the composition of any one of Embodiments 4-38, further comprising a dispersant.

Embodiment 40 provides the composition of Embodiment 39, wherein the dispersant is in a range of from about 0.1 wt % to about 5 wt % of the composition.

Embodiment 41 provides the composition of any one of Embodiments 39 or 40, wherein the dispersant is in a range of from about 0.1 wt % to about 0.5 wt % of the composition.

Embodiment 42 provides the composition of any one of Embodiments 4-41, further comprising a defoamer.

Embodiment 43 provides the composition of Embodiment 42, wherein the defoamer is free of a silicone.

Embodiment 44 provides the composition of any one of Embodiments 4-43, further comprising a rheology modifier or thickener.

Embodiment 45 provides the composition of Embodiment 44, wherein the rheology modifier is in a range of from about 0.1 wt % to about 5 wt % of the composition.

Embodiment 46 provides the composition of any one of Embodiments 44 or 45, wherein the rheology modifier is in a range of from about 1 wt % to about 4 wt % of the composition.

Embodiment 47 provides the composition of any one of Embodiments 44-46, wherein the rheology modifier is a thickener comprising hydroxyethyl cellulose, methyl cellulose, carboxymethyl cellulose, hydroxyethylcellulose, hydrophobically modified, an alkali swellable emulsion, a hydrophobically modified ethoxylated urethane, hydrophobically modified analogues thereof, a natural or synthetic gum thereof, or a mixture thereof.

Embodiment 48 provides the composition of any one of Embodiments 4-47, wherein the composition is substantially free of a chelator.

Embodiment 49 provides the composition of Embodiment 48, wherein the chelator is ethylenediaminetetraacetic acid (EDTA).

Embodiment 50 provides the composition of any one of Embodiments 1-49, wherein a viscosity of the composition is in a range of from about 70 KU to about 130 KU.

Embodiment 51 provides the composition of any one of Embodiments 1-50, wherein a viscosity of the composition is in a range of from about 80 KU to about 115 KU.

Embodiment 52 provides the composition of any one of Embodiments 1-51, wherein a pH of the composition is in a range of from about 6 to about 9.5.

Embodiment 53 provides the composition of any one of Embodiments 1-52, wherein a pH of the composition is in a range of from about 7.5 to about 9.

Embodiment 54 provides the composition of any one of Embodiments 1-53, wherein the composition is a paint, an elastomeric coating, a caulk, a sealant, a floor polish, a fabric treatment, a secondary coat, or a primer.

Embodiment 55 provides the composition of any one of Embodiments 1-54, wherein the composition is configured to kill a microbe chosen from Staphylococcus aureus, Enterobacter aerogenes, Pseudomonas aeruginosa, Methicillin Resistant Staphylococcus aureus, E. coli, and mixtures thereof.

Embodiment 56 provides a method of making the composition of any one of Embodiments 4-55, the method comprising:

combining the inorganic glass comprising copper, one or more emulsion polymers, pH modifier, and water to form a composition precursor; and

mixing the composition precursor to form the composition.

Embodiment 57 provides the method of Embodiment 56, wherein at least one of the glass comprising copper, one or more emulsion polymers, and pH modifier are a powder.

Embodiment 58 provides a dried product of the composition according to any one of Embodiments 1-57.

Embodiment 59 provides the dried product of Embodiment 58, wherein the inorganic glass comprising copper is heterogeneously distributed about the dried product.

Embodiment 60 provides the dried product of any one of Embodiments 58 or 59, wherein a major portion of the inorganic glass comprising copper is proximate to a surface of the dried product.

Embodiment 61 provides the dried product of any one of Embodiments 1-60, further comprising a secondary coat at least partially covering the dried product.

Embodiment 62 provides the dried product of Embodiment 61, wherein the secondary coat is porous.

Embodiment 63 provides an assembly comprising:

a substrate; and

the composition of any one of Embodiments 1-57 or the dried product of any one of Embodiments 57-62.

Embodiment 64 provides the assembly of Embodiment 63, wherein the substrate comprises wood, a plastic, a metal, a ceramic, a stone, cement, drywall, fiberboard, paint, or a mixture thereof.

Embodiment 65 provides a method of making the assembly of any one of Embodiments 63 or 64, the method comprising:

applying the composition to at least a portion of the substrate; and

drying the composition thereon.

Embodiment 66 provides the method of Embodiment 65, wherein the composition is applied to the substrate by spray coating, roller coating, curtain coating, or a combination thereof.

1. A composition for forming a biocidal coating having a log reduction of at least 2 and a CIEL*a*b* delta E* less than about 30.

2. The composition of claim 1, wherein the log reduction is at least 3.

3. The composition of claim 1, wherein the CIEL*a*b* delta E*is less than about 6.

4. The composition of claim 1, wherein the composition comprises:
an inorganic glass comprising copper;
one or more emulsion polymers;
a pH modifier; and
water.

5. The composition of claim 4, wherein the inorganic glass comprising copper is in a range of from about 0.01 wt % to about 15 wt % of the composition.

6. (canceled)

7. (canceled)

8. The composition of claim 4, wherein the inorganic glass comprises SiO₂ nanoparticles, alumina nanoparticles, or mixtures thereof.

9. The composition of claim 4, wherein the copper is in a range of from about 5 wt % to about 80 wt % of the inorganic glass comprising copper.

10. (canceled)

11. The composition of claim 4, wherein the copper is Cu metal, Cu⁺, Cu²⁺, or a combination of Cu⁺ and Cu²⁺.

12. (canceled)

13. The composition of claim 4, wherein the one or more emulsion polymers have a weight-average molecular weight of at least 25,000 Daltons.

14-16. (canceled)

17. The composition of claim 4, wherein one or more emulsion polymers include a repeating unit derived from a polymerizable phosphorous-containing monomer, an acetoacetoxy-functional acrylate, an acetoacetoxy-functional methacrylate, an acetoacetoxy-ethylmethacrylate, or a mixture thereof.

18. (canceled)

19. (canceled)

20. The composition of claim 4, wherein a pKa of the pH modifier is in a range of from about 4.7 to about 9.5.

21. (canceled)

22. The composition of claim 4, wherein the pH modifier is in a range of from about 0.1 wt % to about 5 wt % of the composition.

23-25. (canceled)

26. The composition of claim 4, wherein the pH modifier comprises potassium hydroxide, sodium hydroxide, 2-amino-2methyl-1-propanol, ammonia, 2-dimethylamino-2-methyl-1-propanol, 2-butylaminoethanol, N-methylethanolamine, 2-amino-2-methyl-1-propanol, monoisopropanolamine, monoethanolamine, N,N dimethylethanolamine, N-butyldiethanolamine, 2-amino-2-ethyl-1,3-propanediol, 2-amino-2-hydroxymethyl-1,3-propanediol, triethanolamine, or a mixture thereof.

27. (canceled)

28. The composition of claim 4, further comprising at least one colorant in a range of from about 0.1 wt % to about 22 wt % of the composition.

29. (canceled)

30. (canceled)

31. The composition of claim 4, further comprising at least one extender in a range of from about 0.1 wt % to about 15 wt % of the composition.

32. (canceled)

33. (canceled)

34. The composition of claim 31, wherein the extender comprises clay, talc, TiO₂, aluminum trihydrate, nepheline syenite, CaCO₃, silica, a flattening agent, barium sulfate, zinc oxide, or a mixture thereof.

35. The composition of claim 4, further comprising at least one pigment in a range of from about 0.1 wt % to about 30 wt % of the composition.

36. (canceled)

37. (canceled)

38. The composition of claim 35, wherein the pigment is TiO₂.

39. The composition of claim 4, further comprising a dispersant in a range of from about 0.1 wt % to about 5 wt % of the composition.

40. (canceled)

41. (canceled)

42. The composition of claim 4, further comprising a defoamer which is free of a silicone.

43. (canceled)

44. The composition of claim 4, further comprising a rheology modifier in a range of from about 0.1 wt % to about 5 wt % of the composition.

45. (canceled)

46. (canceled)

47. The composition of claim 44, wherein the rheology modifier is a thickener comprising hydroxyethyl cellulose, methyl cellulose, carboxymethyl cellulose, hydroxyethylcellulose, hydrophobically modified, an alkali swellable emulsion, a hydrophobically modified ethoxylated urethane, hydrophobically modified analogues thereof, a natural or synthetic gum thereof, or a mixture thereof.

48-53. (canceled)

54. The composition of claim 1, wherein the composition is a paint, an elastomeric coating, a caulk, a sealant, a floor polish, a fabric treatment, a secondary coat, or a primer.

55. The composition of claim 1, wherein the composition is configured to kill a microbe chosen from Staphylococcus aureus, Enterobacter aerogenes, Pseudomonas aeruginosa, Methicillin Resistant Staphylococcus aureus, E. coli, and mixtures thereof.

56-66. (canceled)
